(19) United States
(12) Patent Application Publication
(10) Pub. No.: US 2012/0253972 A1
(43) Pub. Date: Oct. 4, 2012

(54) ELECTRONIC SHARED SHOPPING LIST MANAGEMENT

(75) Inventors: Ilya Oskolkov, Moscow (RU); Artem Kirakosyan, St. Petersburg (RU); Rodion Shishkov, St. Petersburg (RU); Igor Sokolov, Tver (RU)

(73) Assignee: RAWLLIN INTERNATIONAL INC.

(21) Appl. No.: 13/073,969

(22) Filed: Mar. 28, 2011

(51) Int. Cl. G06Q 30/00

(52) U.S. Cl. 705/26.8; 705/27.1; 705/27.2

(57) ABSTRACT

Disclosed are shared shopping systems and techniques based on social graph information and spanning multiple merchant providers. A device can include a component for implementing a shopping portal and include an access security module. Social graph information for use in connection with any of the embodiments described herein can come from internal sources or external sources. In this regard, the object information respecting items selected by users represented by a given user social graph can be stored in storage. The access security module can be configured to categorize the object information according to a set of predetermined criteria and allow access to the object information by others represented in a social graph for the user that have received authorization to access the object information.

### TECHNICAL FIELD

The subject application relates to facilitating electronic commerce via one or more networks via a shared shopping list.

### BACKGROUND

Presently, many users of network applications and services have had experiences with or are familiar with the concept and use of wish list applications and services that provide a user a mechanism to temporarily store online references to items or item links, e.g., goods, services, offers, etc., prior to purchasing these items, and that provide item references to others so that such others may purchase the items as a gift for the user. A conventional wish list schema is directed to a user visiting a shopping web site and selecting an item to purchase where, for a variety of reasons, the user may desire to postpone the immediate purchase of the item. The user may choose to create a wish list associated with a particular shopping site and add the desired items to that wish list. As a result, the user ends up with a wish list that is accessible only with information identifying the user. Thus, if a user wanted a third party, such as a friend or a family member, to view the wish list and/or contribute to it, the user would be required to give each person his personal identifying information, such as username and password.

Additionally, in order to add an item to the user's item list in these conventional applications, the item needs to be found in and selected from a particular website. Items discovered at third party online sources cannot be added directly to the item list. For example, an Internet user who learns of a product at a third party website must first navigate to the site where the user's item list resides, and then search for that item again. Only then can the user add the found item to the user's item list, creating an inconvenient experience to say the least.

Furthermore, typical pre-shopping applications do not allow the user to save product description tags, which may assist a user in selecting the best items in the item lists for later purchase. Such tags may be references to general product categories, manufacturers, names of friends who recommended the item or friends who already own the product of interest, the product's popularity ranking, product reviews, and notifications of the product's related activities. In essence, a typical shopping scenario today consists of a user looking to buy a product, conducting product research at various online and off line sources, and then visiting shopping sites to find and purchase a product. Such systems are not flexible and give users limited options for shopping for and selecting items at different websites.

The above-described deficiencies of today's online shopping systems are merely intended to provide an overview of some of the problems of conventional systems, and are not intended to be exhaustive. Other problems with conventional systems and corresponding benefits of the various non-limiting embodiments described herein may become further apparent upon review of the following description.

### SUMMARY

The following presents a simplified summary in order to provide a basic understanding of some aspects disclosed herein. This summary is not an extensive overview. It is intended to neither identify key or critical elements nor delineate the scope of the aspects disclosed. Its sole purpose is to present some concepts in a simplified form as a prelude to the more detailed description that is presented later.

Various embodiments for a shared shopping system are described herein based on social graph information and spanning multiple merchant providers. An exemplary device can include a component for implementing a shopping portal according to one or more of the above-described embodiments. The device can further include an access security module. Social graph information for use in connection with any of the embodiments described herein can come from internal sources or external sources. In this regard, the object information respecting items selected by users represented by a given user social graph can be stored in storage. Data storage of the device can be configured to store object information related to items for user consumption from disparate online merchants in a data representation associated with a user. The access security module can be configured to categorize the object information according to a set of predetermined criteria and allow access to the object information by others represented in a social graph for the user that have received authorization to access the object information according to the various embodiments.

In another non-limiting embodiment, content related to items for user consumption from disparate online merchants can be stored in a data representation associated with a user. The device can receive a request to access the content from another computing device associated with a member, other than the user, of a social network defined by social graph information associated with the user. The request to access the content can be granted or denied as a function of permissions determined for the member from the social graph information.

In another non-limiting embodiment, object information related to items for sale from disparate online merchants can be stored in a data representation associated with a user. The object information can be categorized and displayed according to predetermined criteria. Whether received or determined, access information is obtained for others, represented in social graph data representing a social graph for the user, that have received authorization to access the object information. The access information is employed in determining what permissions the other users have with respect to user's shared shopping list, and vice versa. Based on the access information, access to the object information by a computing device associated with one of the others represented in the social graph data is either allowed or denied. Also, whether addition of other information to the object information is also either allowed or denied can also be determined based on the access information.

These and other embodiments are described in more detail below.

### BRIEF DESCRIPTION OF DRAWINGS

FIG. 1 illustrates an example of internal Bag components (minimized and maximized grid view);

FIG. 2 illustrates an example of an unauthorized user view;

FIG. 3 illustrates a maximized Bag view;

FIG. 4 illustrates a minimized Bag view;

FIG. 5 illustrates a full screen size grid product order view;

FIG. 6 illustrates a full size scroll product order view;

FIG. 7 illustrates the components and functionality of a downloading progress bar;

FIG. 8 illustrates an example of a main menu functionality;

FIG. 8a illustrates a process of navigating to another service member's Bag;

FIG. 9 illustrates exemplary functionality provided by the statistics menu;

FIG. 9a illustrates exemplary further functionality provided by the statistics menu;

FIG. 10 illustrates options for viewing product card;

FIG. 11 illustrates an example of a process of adding item to Bag from shopping web portal;

FIG. 12 illustrates an example of a process of adding item to Bag from third party web space;

FIG. 13 illustrates an example of a process of removing item from user's Bag;

FIG. 14 illustrates an example of product card page;

FIG. 15 illustrates an example of a privacy settings screen;

FIG. 16 is a block diagram showing an exemplary non-limiting implementation for a shared shopping system in one or more embodiments;

FIG. 17 is a block diagram illustrating an exemplary non-limiting process for a shared shopping system;

FIG. 18 is a flow diagram illustrating an exemplary non-limiting process for a shared shopping system;

FIG. 19 is a flow diagram showing an exemplary non-limiting implementation of a shared shopping system;

FIG. 20 is a block diagram representing exemplary non-limiting networked environments in which various non-limiting embodiments described herein can be implemented; and

FIG. 21 is a block diagram representing an exemplary non-limiting computing system or operating environment in which one or more aspects of various non-limiting embodiments described herein can be implemented.

### DETAILED DESCRIPTION

Embodiments and examples are described below with reference to the drawings, wherein like reference numerals are used to refer to like elements throughout. In the following description, for purposes of explanation, numerous specific details in the form of examples are set forth in order to provide a thorough understanding of the various embodiments. It will be evident, however, that these specific details are not necessary to the practice of such embodiments. In other instances, well-known structures and devices are shown in block diagram form in order to facilitate description of the various embodiments.

As mentioned, most users of wish lists would reject the notion of sharing private information, such as password information, to third parties due to the sensitive nature of such information. Accordingly, various embodiments herein enable users to share their item list with a third party while retaining control over which information to reveal and to whom, and with a convenient mechanism for enabling third parties of interest to participate. For example, a user may want to ask for friends' opinions about the items in the user's list, ask for friends' recommendations, view what is in the user's list as recommendation ideas and view friends' wish lists as well. In this regard, in one aspect of one or more embodiments disclosed herein, a user's wish list is made accessible to other authorized users, such as the user's friends or other associated entities, e.g., according to a mechanism based on the user's online social presence.

In another aspect of one or more embodiments disclosed herein, users are allowed to choose items from different websites for inclusion in their wish lists. A set of interfaces and methods are provided that enable the user's wish list to be exposed to other users or entities via established social networks and related theme web portals, product databases, and forums. This allows users to add items from third party sources directly to their item list, and also allows them to make the wish list available to other people on a friends list associated with the usernames, or other identifiers, of third party web spaces.

In one example, an electronic item list system such as a wish list, referred to hereafter as “the Bag,” is employed with a shopping portal residing on a server computer that is accessible by a client computer. Methods employed to provide the functionality associated with the electronic item list system are also illustrated and described. A page, such as a hypertext mark-up language (HTML) page, can be displayed at a client and is programmed to be responsive to a user selecting one or more elements displayed on the page. It is noted that although the embodiments and examples will be illustrated with respect to an architecture employing HTML pages and the World Wide Web, the embodiments and examples may be practiced or otherwise implemented with any network architecture utilizing clients and servers, and with distributed architectures, such as but not limited to peer to peer systems.

In one example, a Bag is utilized in a themed social context, where shopping items to be purchased online and related information are shared among users who are associated with each other. Users may add items to their own Bags, and may also recommend items to be added to their friend's bags when authorized. For example, there may be sharing of items and related information with users associated with “Friends” in social networks, where groups of users allow each other to access each other's Bags to add items, comments on particular items, ratings, and other information to enhance the Bag sharing experience among users. This approach opens the social networking community up to a shopping experience that connects products available for purchase with the community collaboration that is widely seen in social networks, where people gather online to share, comment and recommend things to each other. Retailers and shopping portal websites may also take advantage by providing their own enhancements that enable the collaboration among users.

In one example, a user interface control, such as, but not limited to, a tool bar button, e.g., a user interface control indicating “Add to Bag”, may be installed on a web browser for selection by a user. Thus, as an example usage, when a user is shopping around different websites, the Add to Bag control or button may be selected to add the item being viewed to the user's Bag, or a drop down menu from the Add to Bag control, as another example, may enable the user to add the item being viewed to a friend of the user's Bag. Optionally, for instance, the user may then be queried “Are you sure you want to add this item to your Bag?” or “Are you sure you want to add this item to USER-B's Bag?” (a friend user for example), and the user may then confirm addition of the item to the desired Bag. It is noted that such implementation specific details are described herein for illustrative purposes only, and are not considered limiting on the concepts expressed by the underlying capabilities of the various embodiments.

In one non-limiting embodiment, by gathering information about where the item is located on a user's display screen, either explicitly, e.g., through layout information provided by a merchant, or implicitly, e.g., through information gathered from analysis of the web site markup, a visualization of the item moving from the web site display to a selected Bag can be effected. Based on similar mappings that can be generated between items on display at a merchant site and the Add to Bag control, in one non-limiting embodiment, a user can drag and drop the item with a pointing device such as a mouse, through a visualization overlay, from the location on screen to the Add to Bag control to effect the addition of the item to the Bag or a user's friend's Bag.

In another non-limiting example, the item may be selected, and a separate catalogue may be queried to determine whether the item is available in that catalogue. If available, then it is added to the Bag with an indicator related to the catalogue reference for later review or purchase. If it is not available in the catalogue, on back order, simply not existent, then an alternative item may be presented to the user for inclusion in the Bag. In this example, the catalogue provider may be limited in the items it can offer users, or may actually provide multiple alternative items and also price alternatives for the same or different items.

While availability can be taken into account in connection with addition to a Bag or not, in the content of a social network, it is not particularly relevant whether an item is in stock or not. Thus, in another embodiment, the Add to Bag control can also allow a user to add an item that is unavailable, or in pre-sale, to the Bag and wait until it comes available. This also assists the merchant in supply management—“what are users looking to buy?”, and help enable the supply chain stay consistent with demand for products whether in stock or not. Moreover, the Bag, through its interfaces with the merchants' back ends, can notify the user or a user's friend when the item becomes available, or once the pre-sale period terminates.

In yet another example, the system may include a combination of both a broad online access to different websites together with a catalogue. The catalogue may possibly be sponsored by a particular shopping portal or an aggregator of different shopping portal websites. In either configuration, commercial interests and consumers alike will likely promote a more robust, open and resourceful shopping experience where users may share items and related information with each other to make products and services more widely available and visible among users.

Once the items are captured and saved in the Bag, users and friends of users within the social context can collaborate and share information related to Bag items, enhancing the shopping experience through social networking. The experience may closely emulate shopping together with friends in a mall, but with a robust cadre of different types of information and services that make shopping for items in a broad spectrum of products and services available from different sources. Users that are mutually connected to each other via social networks may share items and related information with each other in a very open and free flowing manner.

In one example from a user's perspective, a user may be shopping for a portable music player at at an online retail service. The user may press the “Add to Bag” button on the user's browser. If a catalogue is associated, the browser may connect to the catalogue database and search out the item. If it contains the item desired, the portable music player in this example, then the browser may open a new page in the browser's tab. It may then ask the user to confirm adding the item to the bag, such as “Add this item to your Bag?”, and would add the item and any related information to the user's Bag, opening up the item for access and comment or other access and use by the user and any user's friends. If, however, the item is not available or on back order for example, the system may indicate to the user that the item is not available, not in stock, or on backorder, and give the user other options. One option may be an offer to remind the user when the item becomes available, perhaps sending the user a message when the item is available. This action may time out or expire over a period of time, or may provide periodic updates on the item to the user. The options may also be configurable by the user. For example, the user may be presented with an option box that allows a user to request an update for a period of time, email reminder, text message, indicator next to the item within the bag to show availability, or other indicator. The user may also be offered to choose other related items that are similar, cheaper, available, or somehow related. The user may be offered items that other users have chosen when they viewed the initial item, or perhaps items that their friends may have purchased in connection with the item of interest. Different scenarios and schemes may be configured according to the various embodiments, and those skilled in the art will understand that other related and naturally intuitive extensions of the concepts and examples described herein will be possible given this disclosure. Such extensions or related enhancements or examples will also be understood to be within the spirit and scope of the subject disclosure, defined by the appended claims and their equivalents, and also future presented claims and their equivalents based on the various embodiments disclosed herein. In one example from a user's perspective, an Internet user may be browsing at a library of articles and find a reference to a film, which user is interested to purchase. The user may navigate to a film description page of the library and press the “Add to Bag” button on the user's browser toolbar. The application extracts the film title and other essential information and opens a new browser tab presenting the user the Bag login page. Upon successful user authorization, the application scans a web database of the site where user Bag resides, finds the title of user's interest and displays a confirmation dialogue box to the user inquiring if the found title is the same as that which the user had been looking for. Upon user confirmation, application adds the item to the Bag. Now the user may purchase the item in the Bag immediately or at any later time.

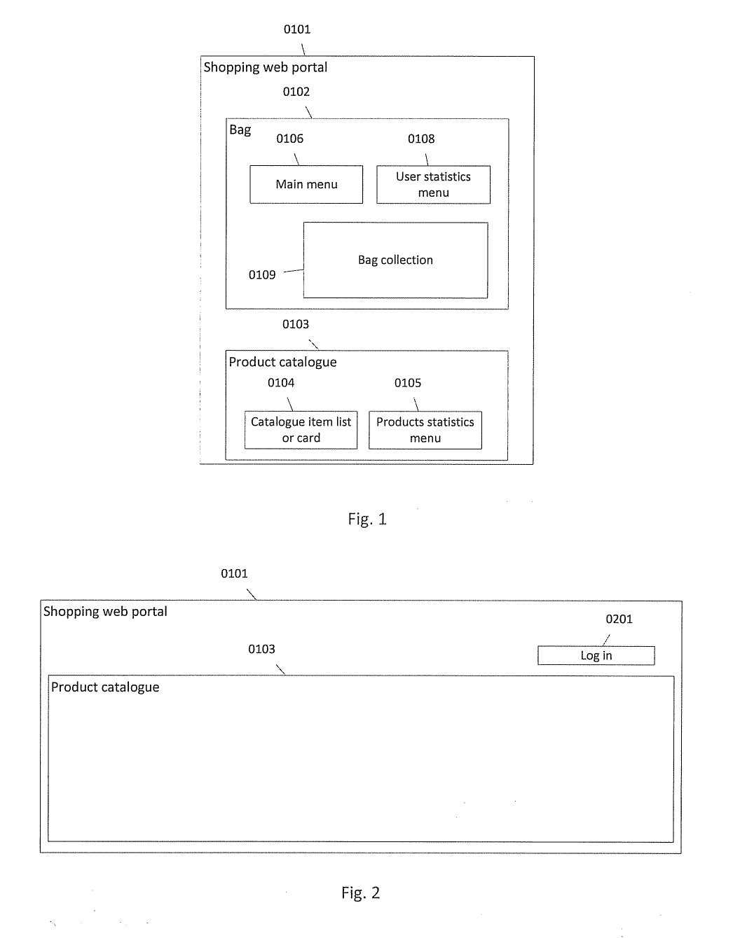

In an illustrative example, FIG. 1 shows a shopping web portal 0101, where a product catalogue 0103 and user Bag 0102, reside. The product catalogue section 0103 is an area where a user can search for products contained in the shopping web portal catalogue. Two sections of the product catalogue area 0103 are a catalogue item list or card 0104 and products statistics menu 0105. The Bag 0102 is where a user collects references to favorite products from the product catalogue 0103 of a shopping web portal 0101. The Bag includes four main sections: main menu 0106, user statistics menu 0108, and a Bag collection 0109, where lists or descriptions of added to Bag 0102 items are displayed.

FIG. 2 illustrates an example of a Bag view of the same shopping web portal 0101 from the point of view of a user that is not authorized access the Bag, a guest user. When a guest first arrives at the shopping web portal 0101, the Bag is hidden. A user may browse the product catalogue 0103, add new items to the Bag, but in order for a guest to see and save newly added items to the Bag, the guest must first be signed into the system. Hence, the login/register link 0201 is displayed to allow user authorization. After the user logs in at the web shopping portal, the user is presented with a maximized Bag view.

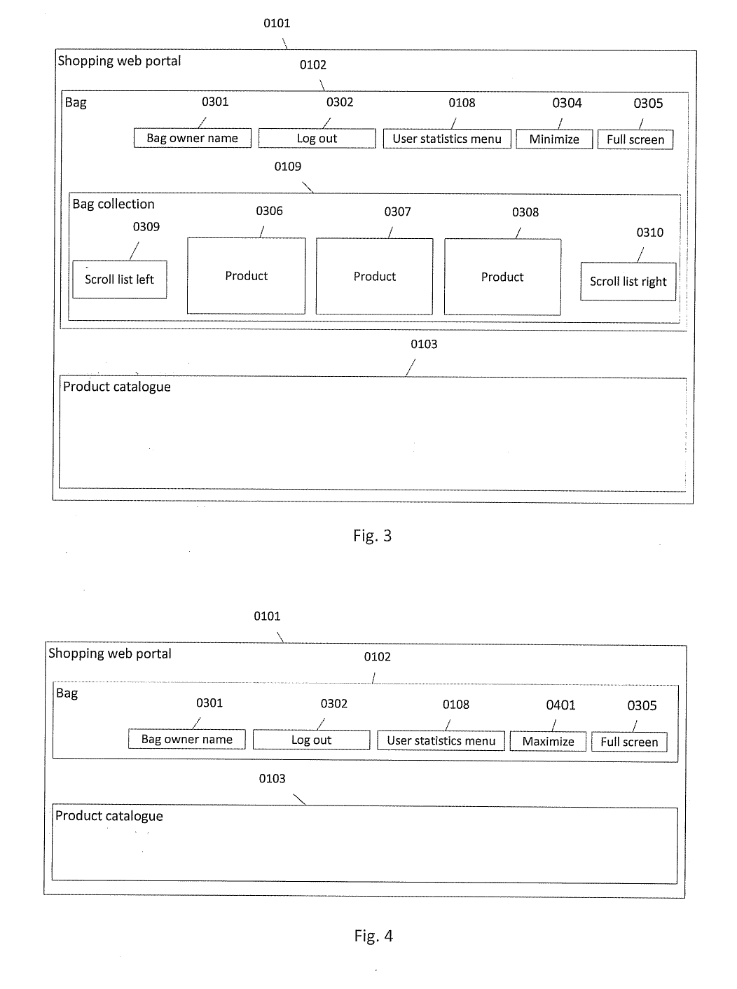

FIG. 3 illustrates an example of a maximized Bag view. In one embodiment, the Bag 0102 may be persistently present at the top of every page. To indicate user active login the Bag owner's name 0301 is displayed, as well as a logout link 0302 to allow the user to sign off of the system and close the Bag. In one example, this view appears as a tall horizontal bar additionally revealing the user's statistics menu 0108, product lists 0306, 0307, 0308, that include product titles, small scrollable product snapshots next to it, and navigation links to scroll left 0309 or right 0310 to allow a user to browse the items list. Here, a user may choose to maximize the Bag view by clicking on the maximized link 0304, or full screen views by clicking on the full screen link 0305 to hide or reveal information, and change product snapshot sizes and level of description details.

FIG. 4 illustrates an example of a minimized Bag view. In this example, the minimized Bag appears as a thin horizontal belt. The bag collection area 0109 is hidden here, which allows the expanding of the product catalogue area 0103, making it more convenient for catalogue browsing. This example of a minimized view contains the Bag owner's name 0301, logout link 0302, user statistics menu 0108. And, in place of maximize link 0304, minimized link 0401 appears. Furthermore, a user may click on the full screen link 0305 to switch to the full screen Bag view to expand the Bag by sliding the horizontal bar down the page and locking it to the bottom of the web browser. This hides the product catalogue area 0103 for more convenient Bag browsing.

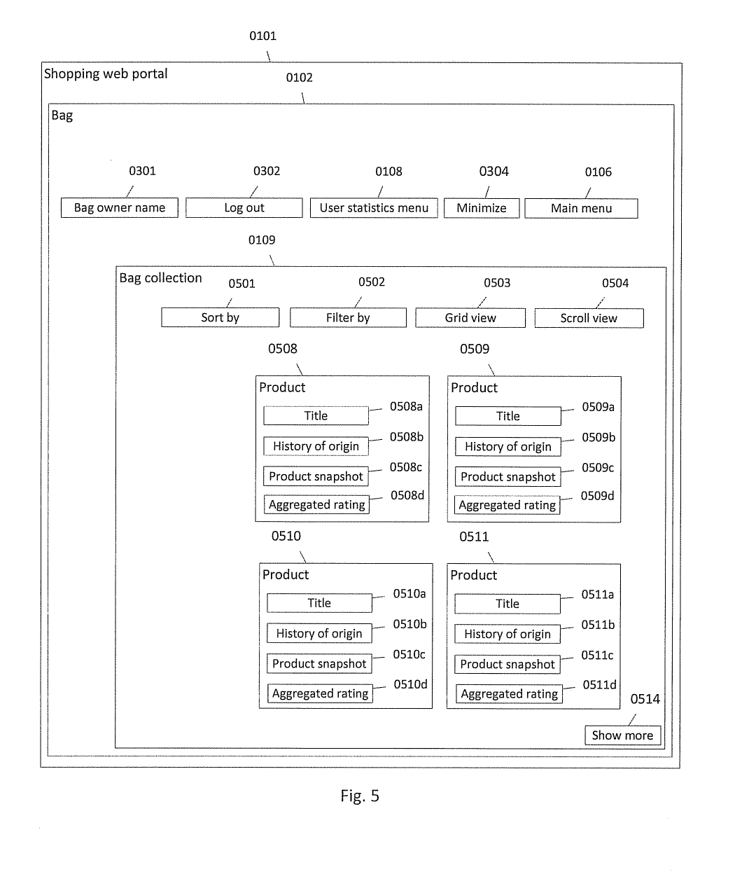

FIG. 5 illustrates an example of a full screen size grid product order view. Here in addition to the Bag owner's name 0301, logout link 0302, user statistics menu 0108, minimize 0304 link, a user can see links for extended functionality. These are sorted by 0501 and filtered by 0502 drop-down menus, main menu 0506, and user activities summary menu 0507. Also, in the Bag collection area 0109, a user can view product listings 0508, 0509, 0510, 0511, their respective titles 0508a, 0509a, 0510a, 0511a, history of the items' origin 0508b, 0509b, 0510b, 0511b, product snapshots 0508c, 0509c, 0510c, 0511c, and aggregated ratings 0508d, 0509d, 0510d, 0511d. In one example, the default ordering schema is a grid view. To scroll through a Bag collection, a user may click on the show more navigation link 0514 at the bottom of each page. While in grid full view, a user may click on the scroll view link 0504 to switch the Bag collection display from a grid to a scrollable, carousel-like appearance.

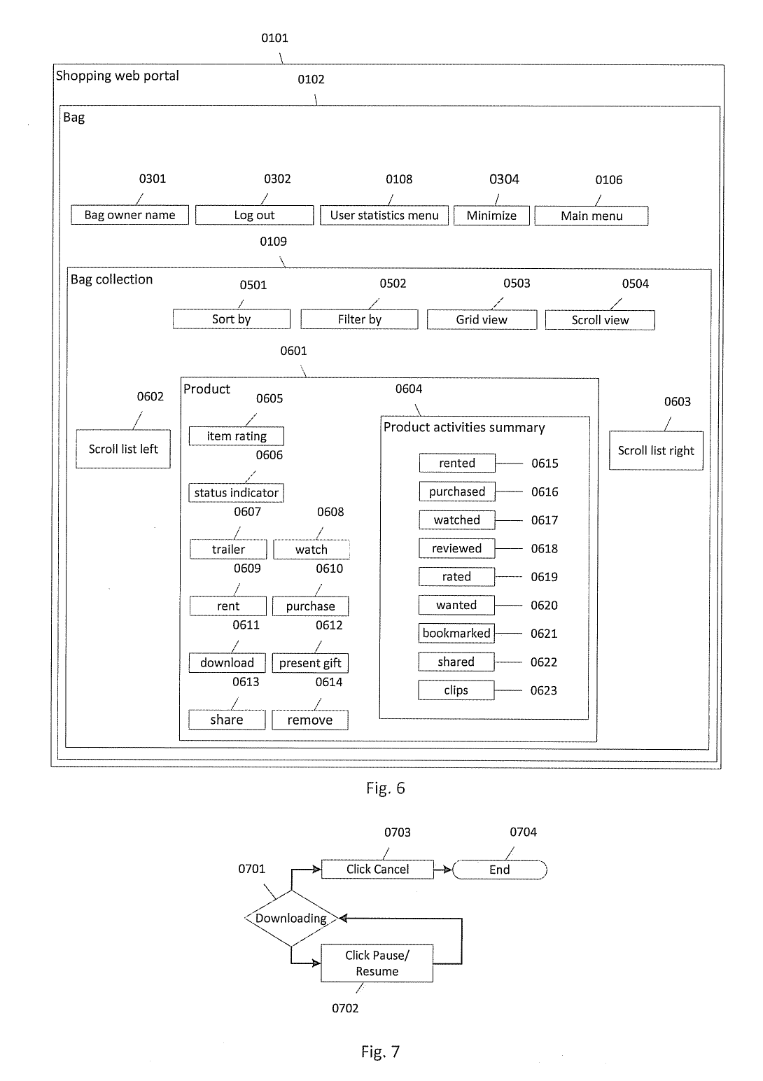

FIG. 6 illustrates an example of a full size scroll product order view. The scroll product order allows the most detailed product display in the Bag area 0102 of the Bag collection. The size of the displayed product 0601 snapshots is such a size that only one item can be viewed at a time with links that allow scrolling to the left 0602 and right 0603 position on each respective side of the displayed item. In addition to the displayed link objects and functionality links available in the grid Bag view, the product area 0601 of the Bag collection 0109 contains an item status indicator 0606 (i.e., new, rented, purchased, received as gifts, downloaded, in process of downloading), item aggregated rating 0605, and product activities menu 0604. There is a number next to each displayed event name representing the combined quantity of friends participating in the corresponding activity. Activities types representing neither of the recent events in the Bag are hidden. By clicking on the activity name, a corresponding list of friends is displayed in the Bag collection section 0109, which, in essence, provides filtering capabilities of the Bag's collection 0109. By clicking on the friend's name link, a user's friend Bag opens in lieu of the user's Bag collection 0109. For example, when clicking on the recently purchased link, the Bag displays the list of friends who purchased this product recently. Product activities 0604 of online video on-demand portal may include the number of friends who rented this item 0615, number of friends who purchased this item 0616, number of friends who watched this item 0617, number of friends who reviewed this item 0618, number of friends who rated this item 0619, number of friends who marked this items as wanted 0620, number of friends who bookmarked this item 0621, number of friends who recommended (shared) this item 0622, and number of published video clips of this item 0623. Additionally, the products related functionality links are presented next to product snapshots. A user may click the link to watch the film trailer 0607, watch film 0608, if the item has already been rented or downloaded, rent 0609, purchase 0610, download 0611, if the item has already been purchased, present as a gift 0612, which means to purchase a film for another service member as a gift, share 0613, which means to recommend a film to one or more other service members, and remove 0614 the item from the user's Bag.

By default, all products displayed in the Bag collection 0109 may be displayed in chronological order. However, in full screen view the product list may be sorted by 0501 date item added, ratings, number of times the information on the item was shared with the user, number of reviews, or alphabetically. An items list may also be filtered by 0502 show all, show recently watched only, show highest rated only, show reviewed only, only show items, which information was shared or recommended by user friends with the user, show film clips only, or other filtering methods. Filtering and sorting may be presented in ascending or descending order.

FIG. 7 illustrates an example of a components and functionality of a downloading progress bar. After a user purchases a film at the shopping web portal, he may want to download the film to his computer. After downloading has begun, a progress bar appears under the film snapshot of the full size Bag view, indicating the download progress status. While watching the progress bar a user may click the pause/resume link 0702 to temporary stop and restart the download process and the cancel link 0703 to terminate the process 0704.

The history of origin is the name of the source from which an item was added to the user's Bag. This feature is designed to assist a user in determining the value of the selection, or to help credit other users for recommending an item. For example, if an item was added by a close friend, it may be more highly regarded by a user compared to a random selection by the system or a recommendation by an unknown user, and thus the system may help users make a better purchasing decision based on the source of product discovery. Thus the history of origin may be the name of a social network, name of an online search engine, friend's name, and the like.

The aggregated rating is the combined item assessment of all service members displayed as a number in percentiles from 1 to 100. Whenever the rating of an item is not set by any user, the message “add your rating” is displayed in place of the rating number.

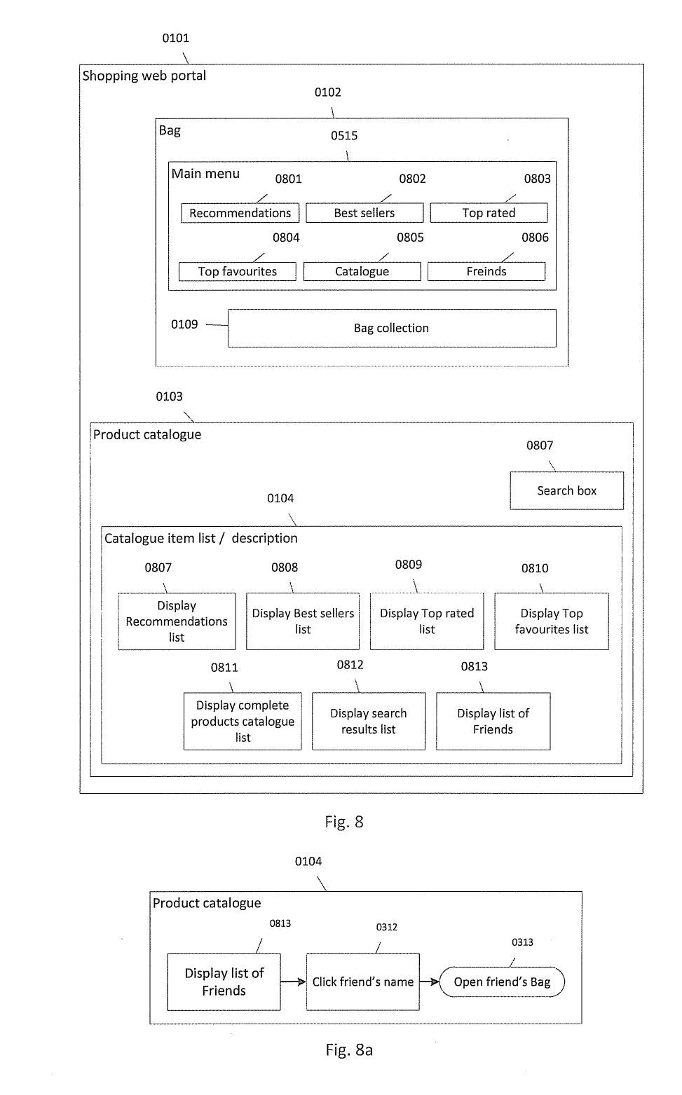

FIG. 8 illustrates an example of functionality provided by a main menu 0106 of a shopping web portal 0101. By clicking on any product title in the Bag collection 0109 of the Bag 0102 or in the product catalogue 0103, a product description page is displayed in the product catalogue 0103. By clicking on the recommendations link 0801, a list of items recommended to the user 0807 is displayed in the catalogue item list section 0104 of the product catalogue 0103, sorted by date. By clicking on the best sellers link 0802, the entire catalogue item list 0808 is displayed in the catalogue item list section 0104 of the product catalogue 0103, sorted by most sold to least sold. By clicking on the top rated link 0803, the entire catalogue items list 0809 is displayed in the catalogue item list section 0104 of the product catalogue 0103, sorted by highest rated to lowest sold. By clicking on the top favorites link 0804, the entire catalogue item list 0810 is displayed in the catalogue item list section 0104 of the product catalogue 0103, sorted by order of items marked as favorites by the most users first to the least. By clicking on the catalogue link 0805, the entire catalogue item list 08011 is displayed in the catalogue item list section 0104 of the product catalogue 0103, sorted in alphabetical order. By clicking on a friend's link 0806, a list of the user's friends 0814 is displayed in the catalogue item list section 0104 of the product catalogue 0103, sorted in alphabetical order. A user may search the entire catalogue by entering keywords into the search box 0807 of the product catalogue section 0103 to display the search results list 0812 in the catalogue item list section 0104. By clicking on any friend's name in the displayed list of friends 0813, the selected friend's Bag is displayed in the Bag area 0102 of the shopping web portal 0101.

FIG. 8a illustrates a process of navigating to another service member's Bag. By clicking on a user's friend name 0312 anywhere in the shopping web portal 0101, for example, in the display of list of fiends 0813 of the product catalog area 0104, selected service member's Bag will appear 0313.

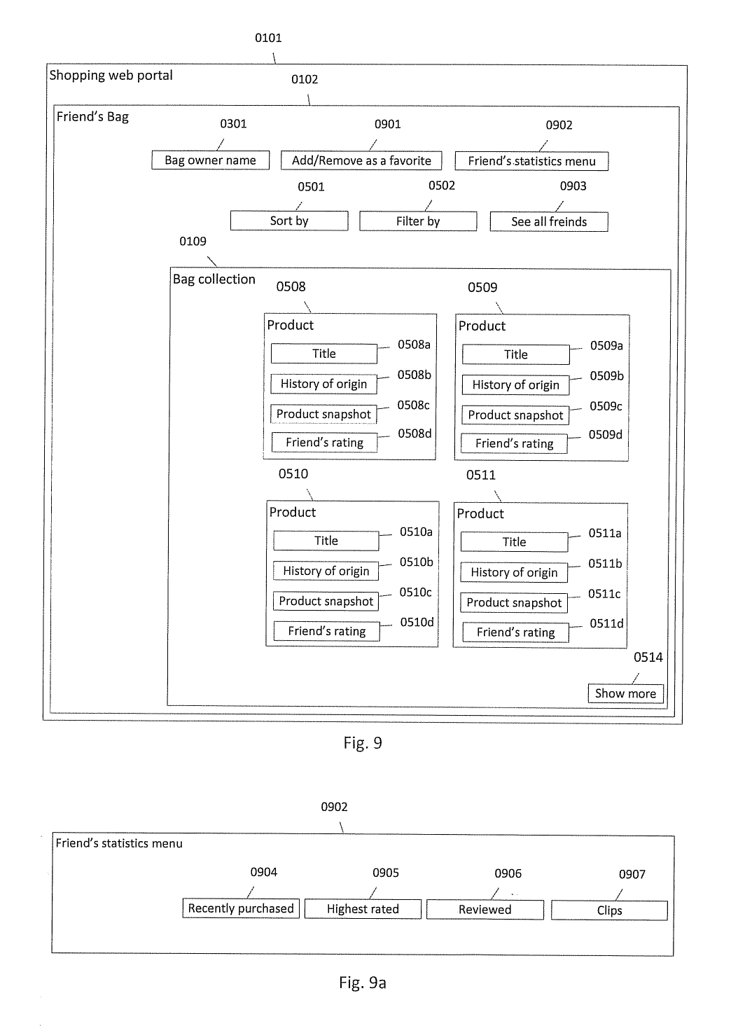

FIG. 9 illustrates friends Bag view, which is very similar in appearance to the full screen size grid product order view presented in FIG. 5. Here are friend's name 0301 whose Bag is displayed, and add/remove as a friend link 0901, which allows the user to add friend to the list of most valued sources of product references. Item recommended by the favorite friends are highlighted in the user list of recommended items. Additionally, here is a friend's statistics menu, 0902, sort by 0501 and filter by 0502 menus, each one designed to assist the user in navigating around friend's Bag content. Also, there is a see all friends link 0903, which returns user to display of complete list of user friends 0813. Furthermore, here is a Bag collection 0109, which included snapshots of product items contained in the Bag 0508, 0509, 0510, 0511, each including the items' titles 0508a, 0509a, 0510a, 0511a, history of items' origin 0508b, 0509b, 0510b, 0511b, which indicates the name of the source from where the item was added to the friend's Bag. For example, name of social network, the name of a person who recommended the item, the name or the search engine from which item was found, etc. Product snapshots also include the product images 0508c, 0509c, 0510c, 0511c and the rating assigned to the item by the Bag owner 0508d, 0509d, 0510d, 0511d.

FIG. 9a illustrates the friend's statistic menu links 0902. Next to each link is the number representing the volume of items in the specified status. For example, the menu may contain links to recently purchased list 0904, highest rated list 0905, items for which Bag owner submitted a review 0906 and the list of clips made by the Bag owner 0907.

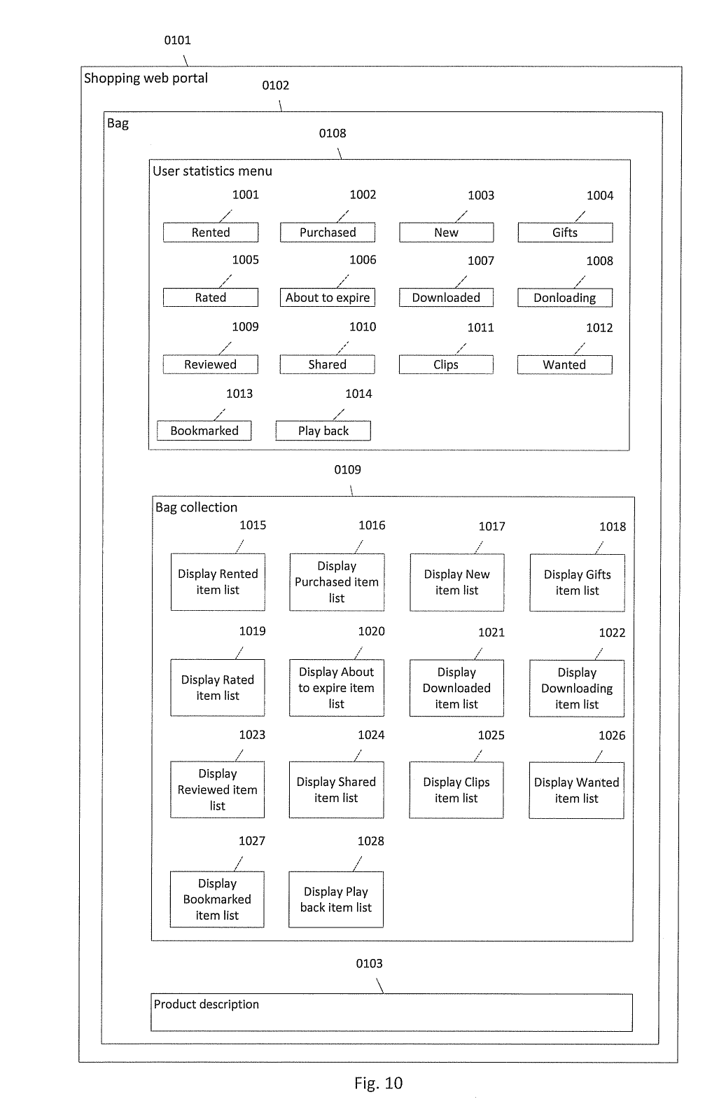

FIG. 10 illustrates an example of functionality provided by the statistics menu 0108 of a shopping web portal 0101. The statistics menu allows users a simple way of filtering a Bag's items by their statuses and a quick way of alerting the Bag owner of the most important events related to the Bag's items. There is a number next to each displayed status name representing the combined quantity of product titles in the corresponding status. Status types not representing statuses of any of the products title in the Bag are hidden. By clicking on the status name, a corresponding list of items is displayed in the Bag collection section 0109, which, in essence, provides filtering capabilities of the Bag collection 0109. Thus, by clicking on the rented link 1001, the Bag displays a list of all rented items 1015, by clicking on the purchased link 1002, the Bag displays a list of all purchased items 1016, by clicking on the new link 1003, the Bag displays a list of all recently added to the Bag items 1017, by clicking on the gifts link 1004, a list of all items received by the user as a gift from other users 1018 is displayed. Clicking on the rated link 1005, displays a list of all rated items 1019 in ranking order. Clicking on the about to expire link 1006, displays a list of all rented items 1020, which lists the respective time periods for which watching privileges for the respective rented items are about to expire, e.g., in order of date of expiration of the time periods. Clicking on the downloaded link 1007, displays a list of all downloaded items 1021 in alphabetical order. Clicking on the downloading link 1008, displays a list of items which are currently in the process of downloading 1022 in order of progress status. Clicking on the reviewed link 1009, displays a list of all reviewed items 1023 in alphabetical order. Clicking on the shared link 1010, displays a list of all items recommended from the user's friends 1024 in order of highest number of recommendations first to lowest. Clicking on the clips link 1011, displays a list of all video clips 1025 the user's friends published in alphabetical order. Clicking on the wanted link 1012, displays a list of all items marked by the user as wanted 1026 in alphabetical order. Clicking on the bookmarked link 1013, displays a list of all bookmarked items 1027 in alphabetical order. Clicking on the play back link 1014, displays a list of all items being played back 1028. By further clicking on any product title in any of the displayed lists of the Bag collection 0109 of the Bag 0102 or in the product catalogue 0103, a product description page, referred herein to as a Product card is displayed in the product catalogue 0103.

In one example, a plurality of links to an interface component allows a user to add products to a user's Bag and the user's friends to recommend products to the user. Such items of a product listing may necessarily require basic information including the items title and the item's buy and add to Bag links.—An item can be added to the Bag by clicking Add to Bag link from one of several sources. Add to Bag link or a message indicating that the item is already in the user's Bag may be located next to an item title in the catalogue item list, in item description page, in user's friends Bags, in a list of friend's activities, in the internal search results list, in the list of items recommended by other service members or in third party partnering web spaces such as shopping portals, product news sites, online product databases, social networks user posts, online recommendation and references sites, dictionaries, wikis, forums' and blogs' user posts, search engines, online banner advertisements, decision guides, next to items names in the search result lists of web search engines, and in other locations.

Additionally, an item can be added to the Bag by a custom add-on software application. Such add-on can be downloaded from the shopping web portal 0101 and installed at the user computer in order to enable the “Add to Bag” functionality at non-partnering web spaces. The add-on will place an Add to Bag button in the tools navigation pane of the user's browser. Then when a user is viewing a product web page at a third party websites, the Add to Bag button may be selected to add the item being viewed to the user's Bag. By clicking on the Add to Bag browser button, user activates add-on application functionality which extracts and temporarily stores essential product information, then connects with the web shopping portal 0101, finds the requested item in the products database and adds it to the user's Bag with reference to the product at the shopping web portal 0101, and not at the original source of discovery. However, proper source from which item was added to the Bag will be displayed in the history of origin fields, i.e. 0508b, 0509b, 0510b and 0511b. In the scenario where user attempts to add an item to the Bag, via Add to Bag browser toolbar button, which is already contained in the user Bag, a corresponding message will display to the user.

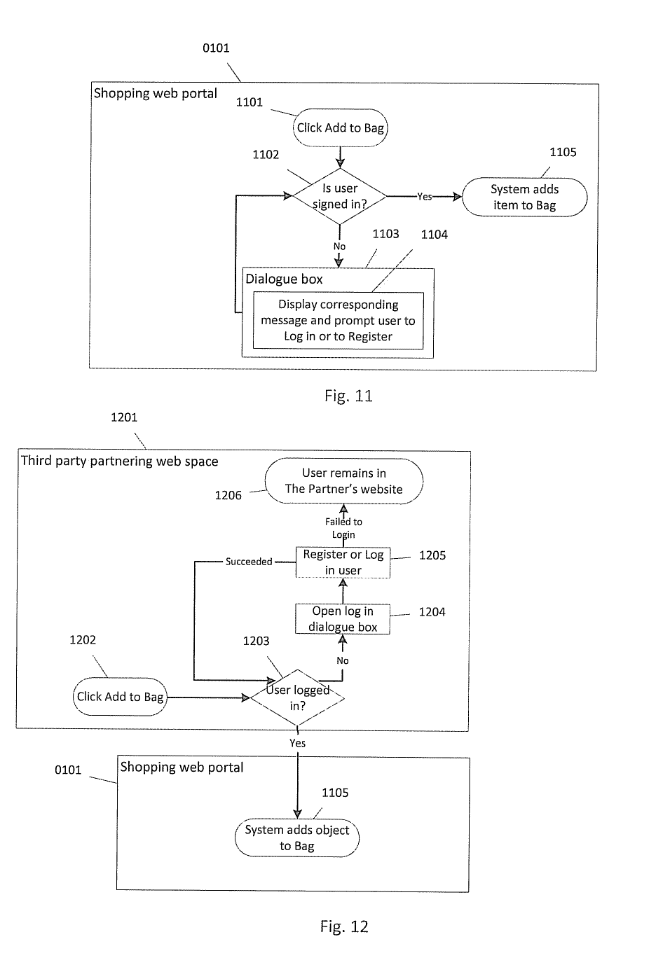

FIG. 11 illustrates an example of an authorization process during a user's attempt to add a new item to the Bag from the shopping web portal 0101 where the user's Bag resides 0102. As mentioned above, in one example, in order for a user to be able to view the Bag and add items from the shopping web portal 0101 where the user's Bag resides, the user may need to be registered at the shopping web portal and be authorized by the system. Thereby, when a user clicks the add to Bag link 1101 at the shopping web portal 0101, the system validates the user's authorization 1102, and, if the user is not logged, the system displays a warning box 1103 requesting the user to register and log in 1104. When a user is successfully authorized, the system adds the item to the Bag 1105.

FIG. 12 illustrates an example of an authorization process during a user's attempt to add a new item to a Bag from a third party non-partnering web space 1201. Thereby, when a user clicks on the add to Bag link 1202 at a third party partnering web space 1201, the third party system validates the user's authorization 1203, and, if the user is not logged on, the system displays a warning box 1204, requesting the user to register and log in 1205. If authorization fails, operation is cancelled and the user remains at the third party website 1206. When a user succeeds to authorize at the partnering third party web space, the system adds the item to the user Bag 1105.

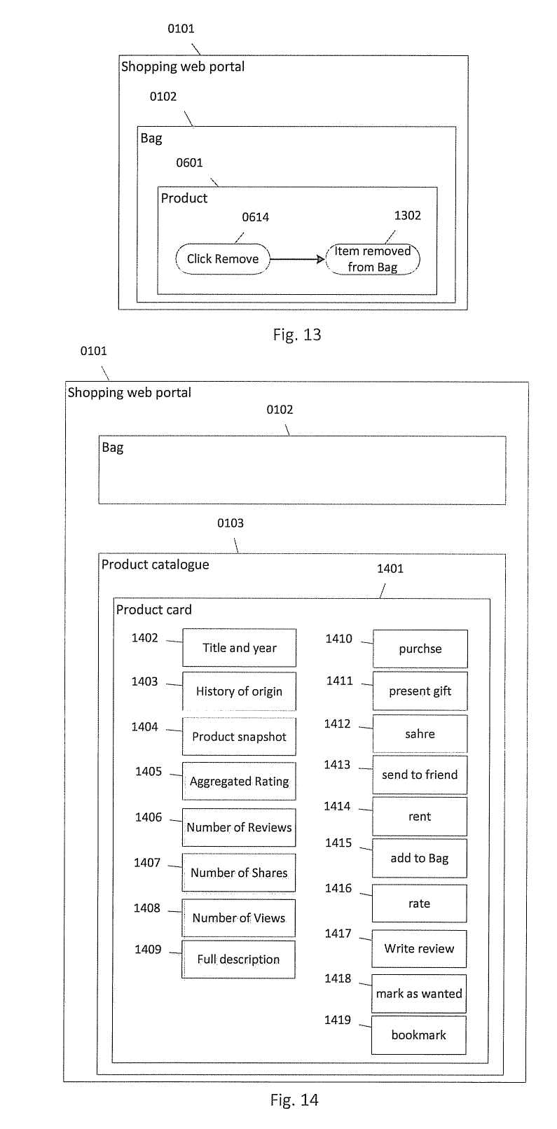

FIG. 13 illustrates an example of a process flow diagram of removing an item from the Bag 0102 of the shopping web portal 0101. An item may be removed by the Bag owner only. In the full screen view scroll order of product section 0601 of the user's Bag 0102 of the shopping web portal 0101, a user may navigate to an item and click the remove link 0614 in the product area 0601 to remove the item from the user's Bag 0102. The system then removes the item 1302.

FIG. 14 illustrates an example of an item card 1401 of the shopping web portal 0101. The product card 1401 provides the most complete details of a product description. All information about the item is contained here. For example, the title and year of production 1402, history of item origin 1403, product snapshot 1404, aggregated rating 1405, number of user reviews 1406, number of time information on the item was shares with the user 1407, and number of views 1408. It also contains the functional item related links, including purchase 1410 that may include where to purchase the item, present item as a gift to other service member 1411 that may include a product source that may effectuate the purchase and delivery as a gift to another person, share information on the item with one or several friends or recommend item to a friend 1412 that may include information related to links for sending recommendations to a friend related to the product, send item information to a friend 1413 that may include simply sending product information to a friend who may or may not be registered with a particular shopping web portal and possibly without any particular recommendation, rent 1414 that may include information related to the ability to rent the product for a limited time such as renting a movie for example, add to Bag 1415 that may include a link or information related to the ability to add the product information as an item to a user's or friend's Bag, rate 1416 that may include information for establishing a rating for the product, write review 1417 that may include information related to enabling a user to write a review on the product or item, mark as wanted 1418 that may include information related to enabling a user to indicate a desire to purchase the product or receive it as a gift, a bookmark 1419 that may include information related to enabling a user to set information to reserve the item for later consideration or purchase, and other information related to the product or item.

While viewing the list of all the product reviews at various views of the Bag area of the shopping web portal or the product catalogue, a user may click on the add review link, and enter and submit a review. Alternatively, from the all reviews list, a user may select a review and click on it to display all the comments selected review. Here a user may click on the add comment to review link, then write and submit it or select a comment and click on add comment to review's comment, then write it and submit it.

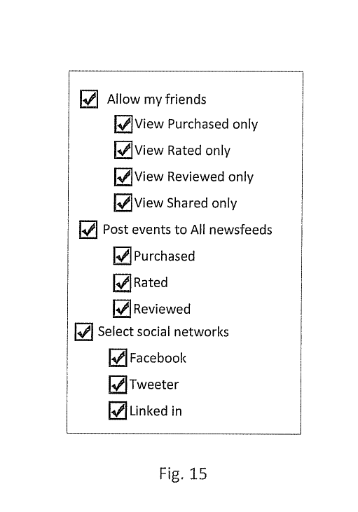

FIG. 15 illustrates an example of the privacy settings of a user's Bag. Privacy settings can be configured by the user in the user preferences section of the shopping web portal. Such setting allows the Bag owner to control what, who and how allowed to view and modify in the user's Bag. Thus, a user may allow all user's friends to view items the user has purchased, view items the user has rated, view items the user has shared or any combination of the above. In addition, a user may define rules for publishing records of the user's activities and send notifications to user's friends, in the event of a purchase, rating and reviewing of a catalogue item by the user. Furthermore, a user may want to share records of the user's activities and publish notifications at a third party online social networking spaces per list available at the shopping web portal 0101.

In various embodiments described herein, reference is made with respect to a user's “social presence” or to a user's “friends” of a “social network.” It is to be noted that such terms are used in an online context to generally to refer to an underlying social graph.

A social graph is a term coined by those working in the social areas of graph theory. It has been described as data structure(s) representing “the global mapping of everybody and how they're related”. Online social networks take advantage of social graphs by examining the relationships between individuals to offer a richer online experience. The term can be used to refer to an individual's social graph, e.g., the connections and relationships pertinent to that individual, or the term can also refer to all Internet users and their complex relationships.

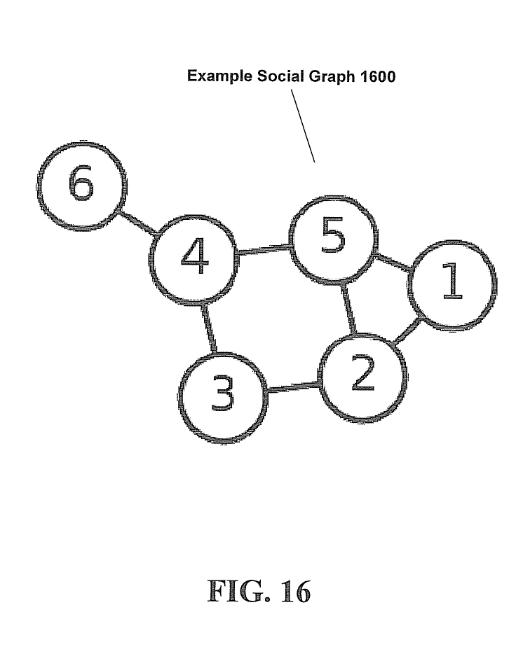

In this regard, while a graph is an abstract concept used in discrete mathematics, a social graph describes the relationships between individuals online, e.g., a representation or description of relationships in the real world. A social graph is a sociogram that represents personal relations. In this regard, a social graph is a data representation, and can be defined explicitly by its associated connections, and stored in or across computer memory(ies). Social graph information can be exposed to websites, applications and services in order to take advantage of the rich information, e.g., demographic information, embodied by the graph information and associated data and metadata about the individuals comprising the graph. Example members 1, 2, 3, 4, 5 and 6 of an exemplary non-limiting social graph of interconnected members 1600 is depicted in FIG. 16.

The concept of a social graph is not limited to just interconnections of people, but rather websites, applications and services can draw information about various objects and information, e.g., photos, audio, events, web pages, etc. and their relationships. This expands the social graph concept to more than just relationships between individuals and instead applies it to virtual non-human objects between individuals, as well.

Thus in various embodiments described herein, each service member can be allocated a personal social space associated with one or more Bags. The personal social space can include list of user virtual friends, which allows users to view the content of their friends' Bags, to view the list of items recommended by the user friends, to search for new items of interest based on friends' commends and dislikes per Personal user context, view the list of friends' social activities, and so on. For instance, the following activity types are considered as social: an item is purchased by a service member's friend, an item is rated by a service member's friend, an item is favoured by a service member's friend, etc., though by no means is the foregoing list inclusive or exhaustive as many other activities are considered social. Further, the user may select items of interest to preview, to add to own Bag or to purchase items, and so on.

Additionally, recommendations can be made based on a member's social graph and may be provided by directly recommending an item with an optional private message to one or more user friends, by rating an item, by writing a review, by commenting to a rating or review submitted by others, etc.

Social data can be homegrown or sourced from third parties, or a combination. For instance, any third party social networks and other online spaces where user interactions is permitted can be leveraged for social mapping information related to a given social graph, such as product discussion forums, fan sites, product news sites, online product databases, online recommendation and references sites, dictionaries, wikis, user blogs', search engines, decision guides, search engines, social network services, etc. Information exchange with social networks can be implemented through open authorization protocol, and depending on the social network related functionality, to allow standard and secure application programming interface (API) multi-domain authentication and authorization without exposing the user's credentials. Thus, optionally, visitors/users may login into the system using their social network accounts or other sources of social data. Additionally, the various embodiments for the above-described Bag services may import from personal user context data, user friends list and aggregated user context data from third party social networks. Furthermore, notifications of user social activities can be posted at the user's social network personal space, and thus the communication with such third-party social network services can be bi-directional, benefitting both systems with additional input. Such interaction provides an opportunity of expanding target audiences beyond a given set of members and allows an opportunity to send communications to third party social network friends, e.g., invitations to third party social network friends (personal or common) to join the service.

Also, the Bag need not be considered a flat structure. The Bag may include multiple levels, e.g., hierarchical levels, some of which may be categorized by the user-owner of the Bag who has ultimate authority of its control and maintenance. A user may categorize different portions of the Bag into areas for maintenance and/or display for different individuals, groups or subgroups. For example, in a social networking environment, a person may want to segregate different areas from various users, such as a parent wanting to show or otherwise share content or information to adult friends separately from children and young adults. A user may further want to separate items that the user chooses or submits into the user's Bag from items other users submit to the user's Bag. The user may also restrict or otherwise control submissions by certain or possibly all users into the user's Bag, and may even prohibit any submissions altogether.

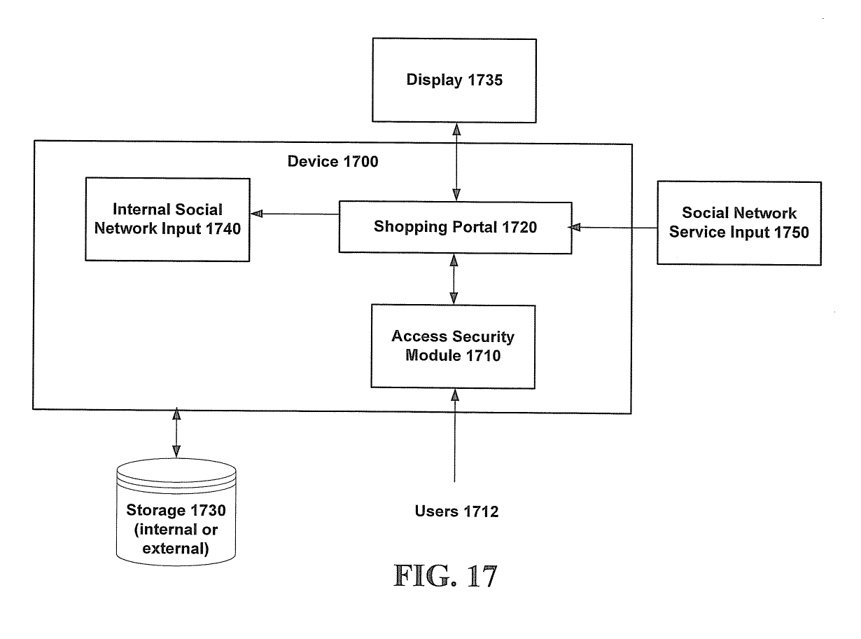

FIG. 17 illustrates an exemplary no-limiting computing device for implementing one or more of the embodiments for the shared shopping systems described herein. A device 1700 can include a component 1720 for implementing a shopping portal according to one or more of the above-described embodiments. The device 1700 can further include an access security module 1710. The device can include or be communicatively coupled to a display 1735. Social graph information for use in connection with any of the embodiments described herein can come from internal sources 1740 or external sources 1750. In this regard, the object information respecting items selected by users represented by a given user social graph can be stored in storage 1730.

Data storage 1730 can be configured to store object information related to items for user consumption from disparate online merchants in a data representation, e.g., the above-described Bag, associated with a user. Access security module 1710 can be configured to categorize the object information according to a set of predetermined criteria and allow access to the object information by others represented in a social graph for the user that have received authorization to access the object information according to the various embodiments.

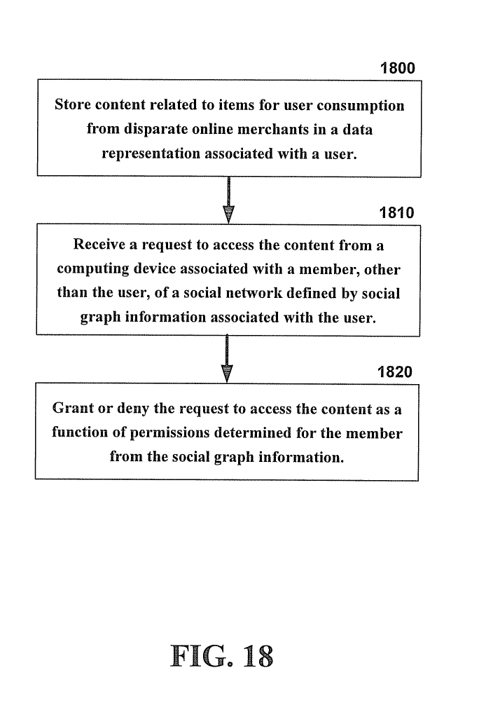

FIG. 18 is a flow diagram illustrating an exemplary non-limiting process for a shared shopping system. As shown, at 1800, content related to items for user consumption from disparate online merchants can be stored in a data representation associated with a user. At 1810, the device can receive a request to access the content from another computing device associated with a member, other than the user, of a social network defined by social graph information associated with the user. At 1820, the request to access the content can be granted or denied as a function of permissions determined for the member from the social graph information.

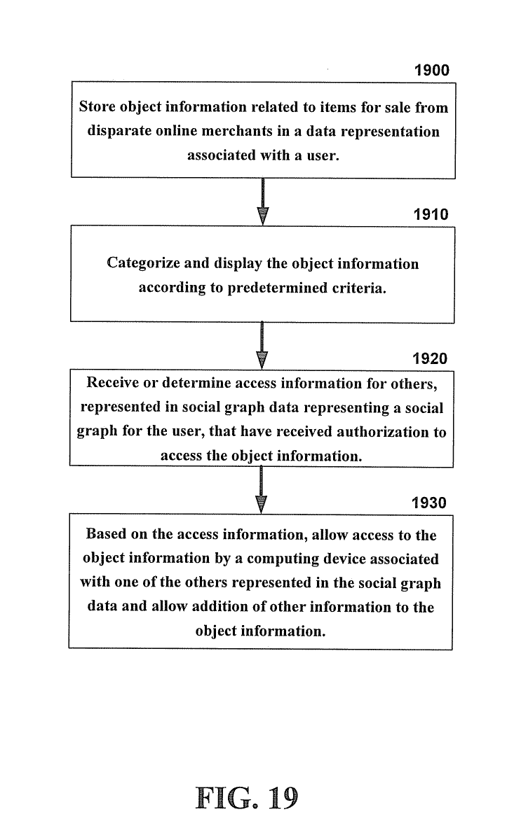

FIG. 19 is a flow diagram showing an exemplary non-limiting implementation of a shared shopping system. At 1900, object information related to items for sale from disparate online merchants can be stored in a data representation associated with a user. At 1910, the object information can be categorized and displayed according to predetermined criteria. At 1920, whether received or determined, access information is obtained for others, represented in social graph data representing a social graph for the user, that have received authorization to access the object information. The access information is employed in determining what permissions the other users have with respect to user's shared shopping list, and vice versa. At 1930, based on the access information, access to the object information by a computing device associated with one of the others represented in the social graph data is either allowed or denied. Also, whether addition of other information to the object information is also either allowed or denied can also be determined based on the access information.

### Exemplary Networked and Distributed Environments

One of ordinary skill in the art can appreciate that the various non-limiting embodiments of the shared shopping systems and methods described herein can be implemented in connection with any computer or other client or server device, which can be deployed as part of a computer network or in a distributed computing environment, and can be connected to any kind of data store. In this regard, the various non-limiting embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the shared shopping mechanisms as described for various non-limiting embodiments of the subject disclosure.

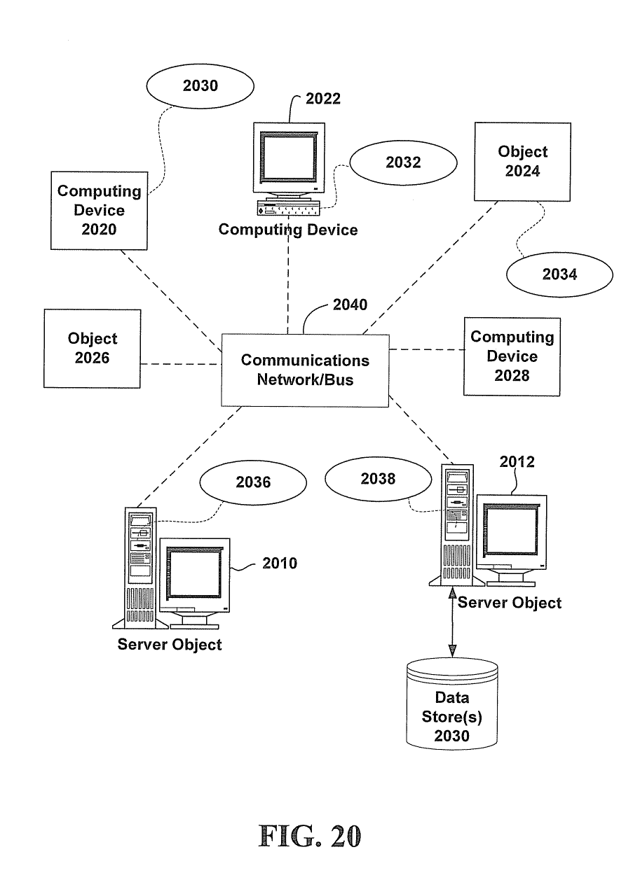

FIG. 20 provides a schematic diagram of an exemplary networked or distributed computing environment. The distributed computing environment comprises computing objects 2010, 2012, etc. and computing objects or devices 2020, 2022, 2024, 2026, 2028, etc., which may include programs, methods, data stores, programmable logic, etc., as represented by applications 2030, 2032, 2034, 2036, 2038. It can be appreciated that computing objects 2010, 2012, etc. and computing objects or devices 2020, 2022, 2024, 2026, 2028, etc. may comprise different devices, such as personal digital assistants (PDAs), audio/video devices, mobile phones, MP3 players, personal computers, laptops, etc.

Each computing object 2010, 2012, etc. and computing objects or devices 2020, 2022, 2024, 2026, 2028, etc. can communicate with one or more other computing objects 2010, 2012, etc. and computing objects or devices 2020, 2022, 2024, 2026, 2028, etc. by way of the communications network 2040, either directly or indirectly. Even though illustrated as a single element in FIG. 20, communications network 2040 may comprise other computing objects and computing devices that provide services to the system of FIG. 20, and/or may represent multiple interconnected networks, which are not shown. Each computing object 2010, 2012, etc. or computing object or device 2020, 2022, 2024, 2026, 2028, etc. can also contain an application, such as applications 2030, 2032, 2034, 2036, 2038, that might make use of an API, or other object, software, firmware and/or hardware, suitable for communication with or implementation of the shared shopping systems provided in accordance with various non-limiting embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the shared shopping systems as described in various non-limiting embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, i.e., roughly a set of instructions or tasks, that requests a service provided by another program or process. The client process utilizes the requested service without having to “know” any working details about the other program or the service itself.

In client/server architecture, particularly a networked system, a client is usually a computer that accesses shared network resources provided by another computer, e.g., a server. In the illustration of FIG. 20, as a non-limiting example, computing objects or devices 2020, 2022, 2024, 2026, 2028, etc. can be thought of as clients and computing objects 2010, 2012, etc. can be thought of as servers where computing objects 2010, 2012, etc., acting as servers provide data services, such as receiving data from client computing objects or devices 2020, 2022, 2024, 2026, 2028, etc., storing of data, processing of data, transmitting data to client computing objects or devices 2020, 2022, 2024, 2026, 2028, etc., although any computer can be considered a client, a server, or both, depending on the circumstances. Any of these computing devices may be processing data, or requesting services or tasks that may implicate the shared shopping techniques as described herein for one or more non-limiting embodiments.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques described herein can be provided standalone, or distributed across multiple computing devices or objects.

In a network environment in which the communications network 2040 or bus is the Internet, for example, the computing objects 2010, 2012, etc. can be Web servers with which other computing objects or devices 2020, 2022, 2024, 2026, 2028, etc. communicate via any of a number of known protocols, such as the hypertext transfer protocol (HTTP). Computing objects 2010, 2012, etc. acting as servers may also serve as clients, e.g., computing objects or devices 2020, 2022, 2024, 2026, 2028, etc., as may be characteristic of a distributed computing environment.

### Exemplary Computing Device

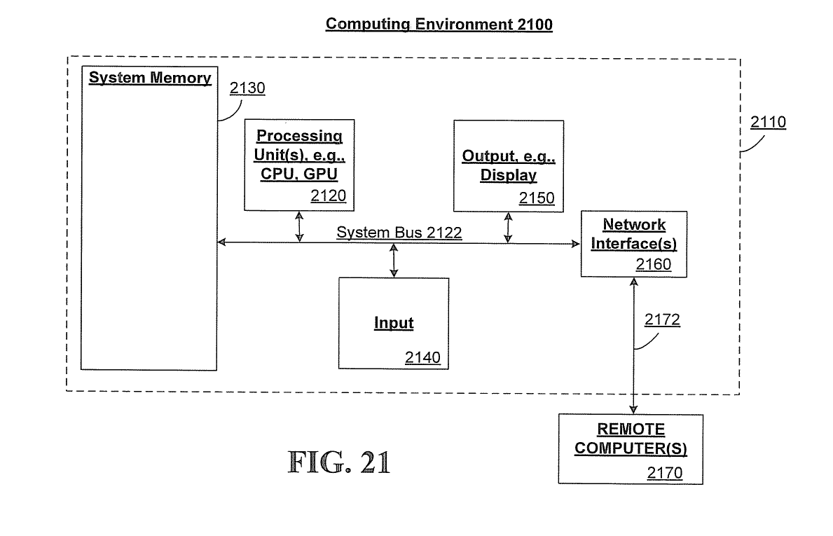

As mentioned, advantageously, the techniques described herein can be applied to any device where it is desirable to facilitate shared shopping. It is to be understood, therefore, that handheld, portable and other computing devices and computing objects of all kinds are contemplated for use in connection with the various non-limiting embodiments, i.e., anywhere that a device may wish to engage in a shopping experience on behalf of a user or set of users. Accordingly, the below general purpose remote computer described below in FIG. 21 is but one example of a computing device.

Although not required, non-limiting embodiments can partly be implemented via an operating system, for use by a developer of services for a device or object, and/or included within application software that operates to perform one or more functional aspects of the various non-limiting embodiments described herein. Software may be described in the general context of computer-executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is to be considered limiting.

FIG. 21 thus illustrates an example of a suitable computing system environment 2100 in which one or aspects of the non-limiting embodiments described herein can be implemented, although as made clear above, the computing system environment 2100 is only one example of a suitable computing environment and is not intended to suggest any limitation as to scope of use or functionality. Neither should the computing system environment 2100 be interpreted as having any dependency or requirement relating to any one or combination of components illustrated in the exemplary computing system environment 2100.

With reference to FIG. 21, an exemplary remote device for implementing one or more non-limiting embodiments includes a general purpose computing device in the form of a computer 2110. Components of computer 2110 may include, but are not limited to, a processing unit 2120, a system memory 2130, and a system bus 2122 that couples various system components including the system memory to the processing unit 2120.

Computer 2110 typically includes a variety of computer readable media and can be any available media that can be accessed by computer 2110. The system memory 2130 may include computer storage media in the form of volatile and/or nonvolatile memory such as read only memory (ROM) and/or random access memory (RAM). Computer readable media can also include, but is not limited to, magnetic storage devices (e.g., hard disk, floppy disk, magnetic strip), optical disks (e.g., compact disk (CD), digital versatile disk (DVD)), smart cards, and/or flash memory devices (e.g., card, stick, key drive). By way of example, and not limitation, system memory 2130 may also include an operating system, application programs, other program modules, and program data.

A user can enter commands and information into the computer 2110 through input devices 2140. A monitor or other type of display device is also connected to the system bus 2122 via an interface, such as output interface 2150. In addition to a monitor, computers can also include other peripheral output devices such as speakers and a printer, which may be connected through output interface 2150.

The computer 2110 may operate in a networked or distributed environment using logical connections to one or more other remote computers, such as remote computer 2170. The remote computer 2170 may be a personal computer, a server, a router, a network PC, a peer device or other common network node, or any other remote media consumption or transmission device, and may include any or all of the elements described above relative to the computer 2110. The logical connections depicted in FIG. 21 include a network 2172, such local area network (LAN) or a wide area network (WAN), but may also include other networks/buses. Such networking environments are commonplace in homes, offices, enterprise-wide computer networks, intranets and the Internet.

As mentioned above, while exemplary non-limiting embodiments have been described in connection with various computing devices and network architectures, the underlying concepts may be applied to any network system and any computing device or system.

Also, there are multiple ways to implement the same or similar functionality, e.g., an appropriate application programming interface (API), tool kit, driver source code, operating system, control, standalone or downloadable software object, etc. which enables applications and services to take advantage of techniques provided herein. Thus, non-limiting embodiments herein are contemplated from the standpoint of an API (or other software object), as well as from a software or hardware object that implements one or more aspects of the shared shopping techniques described herein. Thus, various non-limiting embodiments described herein can have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used, for the avoidance of doubt, such terms are intended to be inclusive in a manner similar to the term “comprising” as an open transition word without precluding any additional or other elements.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it is to be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the described subject matter can also be appreciated with reference to the flowcharts of the various figures. While for purposes of simplicity of explanation, the methodologies are shown and described as a series of blocks, it is to be understood and appreciated that the various non-limiting embodiments are not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

As discussed herein, the various embodiments disclosed herein may involve a number of functions to be performed by a computer processor, such as a microprocessor. The microprocessor may be a specialized or dedicated microprocessor that is configured to perform particular tasks according to one or more embodiments, by executing machine-readable software code that defines the particular tasks embodied by one or more embodiments. The microprocessor may also be configured to operate and communicate with other devices such as direct memory access modules, memory storage devices, Internet-related hardware, and other devices that relate to the transmission of data in accordance with one or more embodiments. The software code may be configured using software formats such as Java, C++, XML (Extensible Mark-up Language) and other languages that may be used to define functions that relate to operations of devices required to carry out the functional operations related to one or more embodiments. The code may be written in different forms and styles, many of which are known to those skilled in the art. Different code formats, code configurations, styles and forms of software programs and other means of configuring code to define the operations of a microprocessor will not depart from the spirit and scope of the various embodiments.

Within the different types of devices, such as laptop or desktop computers, hand held devices with processors or processing logic, and also possibly computer servers or other devices that utilize one or more embodiments, there exist different types of memory devices for storing and retrieving information while performing functions according to the various embodiments. Cache memory devices are often included in such computers for use by the central processing unit as a convenient storage location for information that is frequently stored and retrieved. Similarly, a persistent memory is also frequently used with such computers for maintaining information that is frequently retrieved by the central processing unit, but that is not often altered within the persistent memory, unlike the cache memory. Main memory is also usually included for storing and retrieving larger amounts of information such as data and software applications configured to perform functions according to one or more embodiments when executed, or in response to execution, by the central processing unit. These memory devices may be configured as random access memory (RAM), static random access memory (SRAM), dynamic random access memory (DRAM), flash memory, and other memory storage devices that may be accessed by a central processing unit to store and retrieve information. During data storage and retrieval operations, these memory devices are transformed to have different states, such as different electrical charges, different magnetic polarity, and the like. Thus, systems and methods configured according to one or more embodiments as described herein enable the physical transformation of these memory devices. Accordingly, one or more embodiments as described herein are directed to novel and useful systems and methods that, in the various embodiments, are able to transform the memory device into a different state when storing information. The various embodiments are not limited to any particular type of memory device, or any commonly used protocol for storing and retrieving information to and from these memory devices, respectively.

Embodiments of the systems and methods described herein facilitate the management of data input/output operations. Additionally, some embodiments may be used in conjunction with one or more conventional data management systems and methods, or conventional virtualized systems. For example, one embodiment may be used as an improvement of existing data management systems.

Although the components and modules illustrated herein are shown and described in a particular arrangement, the arrangement of components and modules may be altered to process data in a different manner. In other embodiments, one or more additional components or modules may be added to the described systems, and one or more components or modules may be removed from the described systems. Alternate embodiments may combine two or more of the described components or modules into a single component or module.

Although some specific embodiments have been described and illustrated as part of the disclosure of one or more embodiments herein, such embodiments are not to be limited to the specific forms or arrangements of parts so described and illustrated. The scope of the various embodiments are to be defined by the claims appended hereto and their equivalents.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium.

Computing devices typically include a variety of media, which can include computer-readable storage media and/or communications media, which two terms are used herein differently from one another as follows. Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other. As used herein, unless explicitly or implicitly indicating otherwise, the term “set” is defined as a non-zero set. Thus, for instance, “a set of criteria” can include one criterion, or many criteria.

A number of embodiments have been described. Nevertheless, it will be understood that various modifications may be made without departing from the spirit and scope of the disclosure.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims and their equivalents.

1. A method, comprising:
storing content related to at least two items for user consumption from at least two disparate online merchants in a data representation associated with a user;
receiving a request to access the content from a computing device associated with a member, other than the user, of a social network defined by social graph information associated with the user; and
granting or denying the request to access the content as a function of at least one permission determined for the member.

2. The method of claim 1, wherein the receiving includes receiving the request from a friend of the user represented in the social graph information and the granting or denying includes granting or denying the request based on a permission for the friend determined from the social graph information.

3. The method of claim 1, wherein the granting or denying includes granting or denying the request to access the content according to at least one predetermined access criterion represented in the at least one permission.

4. The method of claim 1, wherein the receiving includes receiving a request to add auxiliary content to the content related to the at least two items and the granting or denying includes granting or denying the request to add the auxiliary content as a function of the at least one permission.

5. The method of claim 4, wherein the granting or denying includes granting or denying a request, from a friend of the user represented in the social graph information, to add the auxiliary content according to at least one predetermined access criterion represented in the at least one permission.

6. The method of claim 5, wherein the granting or denying includes granting or denying a request, from the friend, to add a review of an item of the at least two items according to the at least one predetermined access criterion.

7. The method of claim 5, wherein the granting or denying includes granting or denying a request, from an other friend of the user represented in the social graph information, to add a review of an item added by the friend according to the at least one predetermined access criterion.

8. The method of claim 5, wherein the granting or denying includes granting or denying a request, from the friend, to add a rating of an item of the at least two items according to the at least one predetermined access criterion.

9. The method of claim 5, wherein the granting or denying includes granting or denying a request, from an other friend of the user represented in the social graph information, to add a rating of an item added by the friend according to the at least one predetermined access criterion.

10. The method of claim 5, wherein the granting or denying includes granting or denying a request to add a comment to an item of the at least two items according to the at least one predetermined access criterion.

11. The method of claim 5, wherein the granting or denying includes granting or denying a request, from an other friend of the user represented in the social graph information, to add a comment of an item added by the friend according to the at least one predetermined access criterion.

12. The method of claim 5, wherein the granting or denying includes granting or denying a request to add an item to the at least two items according to the at least one predetermined access criterion.

13. The method of claim 12, wherein the granting or denying includes granting or denying the request to add information associated with the item added to the at least two items according to the at least one predetermined access criterion.

14. The method of claim 1, further comprising:
receiving the social graph information from a data store managed by a social networking service.

15. The method of claim 1, further comprising:
receiving the at least one permission from a data store managed by a social networking service.

16. The method of claim 15, wherein the receiving the at least one permission includes receiving a permission enabling a friend of the user represented in the social graph information to add auxiliary content to the at least two items.

17. The method of claim 15, wherein the receiving the at least one permission includes receiving a permission enabling a friend of the user represented in the social graph information to remove at least some of the content related to the at least two items.

18. The method of claim 15, wherein the receiving the at least one permission includes receiving a permission enabling a friend of the user represented in the social graph information to add an item to the at least two items.

19. The method of claim 15, wherein the receiving the at least one permission includes receiving a permission enabling a friend of the user represented in the social graph information to remove an item from the at least two items.

20. The method of claim 1, further comprising:
identifying an item presented at a merchant website of one of the at least two disparate merchants; and
associating the item presented at the merchant website and an item of the at least two items based on a correlation between the item presented at the merchant website and the item of the at least two items.

21. The method of claim 1, further comprising:
identifying an item presented at a merchant website of one of the at least two disparate merchants; and
associating the item presented at the merchant website and an item of the at least two items based on object information associated with the user represented in the social graph information.

22. The method of claim 21, further comprising:
receiving authorization to perform the associating.

23. The method of claim 21, wherein the associating includes excluding at least a subset of specified items from the associating.

24. A system, comprising:
data storage configured to store object information related to at least two items for user consumption from at least two disparate online merchants in a data representation associated with a user; and
an access security module configured to categorize the object information according to a set of predetermined criteria and allow access to the object information by others represented in a social graph for the user that have received authorization to access the object information.

25. A method, comprising:
storing, by at least one computing device, object information related to at least two items for sale from at least two disparate online merchants in a data representation associated with a user;
categorizing and displaying the object information according to at least one predetermined criterion;
receiving or determining access information for others, represented in social graph data representing a social graph for the user, that have received authorization to access the object information; and
based on the access information, allowing access to the object information by a computing device associated with one of the others represented in the social graph data and allowing addition of other information to the object information by the one of the others.

26. The method of claim 25, wherein the storing includes storing the object information related to the at least two items for sale at different websites in a centralized set of servers.

27. The method of claim 25, wherein the receiving or determining of the access information includes receiving the access information from a computing device associated with a primary user with administrative control over the object information and receiving authorization information from the computing device authorizing the others to access and add to the object information.

28. The method of claim 27, wherein the receiving or determining of the access information includes receiving the access information from a computing device associated with a primary user with administrative control over the object information and receiving authorization information from the computing device authorizing the others to access the object information and add other object information to the object information related to the at least two items for sale.

29. A computer readable storage medium comprising computer executable instructions that, in response to execution by a computing system, cause the computing system to perform operations, comprising:
receiving a selection of an item for purchase from a computing device associated with a user;
storing object information related to the item in a data representation for the user associated with a social graph defined for the user; and
allowing access to the object information by others represented in the social graph that have received authorization to access the object information and add other information to the object information.

30. The computer readable storage medium of claim 29, the instructions further comprising displaying options for storing the object information related to a selected item of the data representation.

31. The computer readable storage medium of claim 30, wherein the displaying the options includes displaying an option to send a message to the user indicating availability of the item for purchase.

32. The computer readable storage medium of claim 29, wherein the displaying the options includes displaying an option to confirm that the object information related to the item is to be stored in the data representation.

33. The computer readable storage medium of claim 30, the instructions further including instantiating a network browser tab in a browser application including initiating a shopping catalogue website portal enabling purchase of the item.

34. The computer readable storage medium of claim 33, the instructions further including presenting an option to add auxiliary object information related to an item for sale to a wish list that is accessible to authorized members of the social graph.

35. A system, comprising:
means for storing content related to items for user consumption from disparate online merchants in a data representation associated with a user;
means for receiving a request to access the content from a computing device associated with a member, other than the user, of a social network defined by social graph information associated with the user; and
means for granting or denying the request to access the content as a function of permission determined for the member from the social graph information.
